(19) United States
(12) Patent Application Publication
(10) Pub. No.: US 2006/0015920 A1
(43) Pub. Date: Jan. 19, 2006

(54) Head end having a low noise converter with channel preselecting frequency multiplexor

(76) Inventors: Pieter Werner Hooijmans, Eindhoven (NL); Cicero Silveira Vaucher, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/528,679

(22) PCT Filed: Aug. 25, 2003
(86) PCT No.: PCT/IB03/50001

§ 371 Date: Mar. 21, 2005

(30) Foreign Application Priority Data
Sep. 24, 2002 (EP) 02078954.1

(51) Int. Cl. H04N 7/173; H04N 7/16

(52) U.S. Cl. 725/127; 725/114; 725/116; 725/145; 725/146

(57) ABSTRACT

A head end (7) comprises a low noise converter (2) for providing signal bands including channels to one or more user units (3). The low noise converter is arranged as a low noise channel converter (2), which includes frequency multiplexing means (6) for multiplexing one or more user pre-selected channels to the user units (3). By effecting pre-selection in the low noise channel converter (2) the connection between the head end (7) and the user units (3) only contains a single communication medium (5), generally an already installed coaxial cable (5). Wanted channels for example for watching one television program and simultaneously recording another program are pre-selected and at the side of the low noise block put on the one cable.

The present invention relates to a head end comprising a low noise converter for providing signal bands including channels to one or more user units, and to a satellite receiver system comprising such a head end.

Such a head end and satellite receiver system are known from EP-A-0 582 023. The known satellite receiver system comprises a head end coupled to an antenna and consisting of what is known as a low noise block or low noise converter, briefly LNB. Each LNB converts received satellite signal bands and is coupled to as many user controlled receiving units often called set-top boxes, if present near a user television set- as there are users. In case of the described four users there are four receiving units and associated respective demodulators connected thereto. These receiving units are coupled to the respective users through a single common cable. User selection of a wanted program or channel takes place by means of a control device associated with each receiving unit.

It is a disadvantage of the prior art satellite receiver system that no flexibility is provided in cases of for example wanted multi-user extensions, wherein a user requires multiple services, which is for example the case if a user would like to watch one program or wants an Internet connection, and simultaneously wants to record another program.

Therefore it is an object of the present invention to provide an improved and more flexible head end and satellite receiver system, whose capabilities with respect to multiple user servicing are extended.

Thereto the head end according to the invention is characterized in that the low noise converter is arranged as a low noise channel converter, which includes frequency multiplexing means for multiplexing one or more user pre-selected channels to the user units.

Similarly the satellite receiver system according to the invention, while it comprises such a head end, is characterized in that the satellite receiver system further comprises one or more user units coupled to the low noise channel converter.

It is an advantage of the head end and satellite receiver system according to the present invention that due to the pre-selection of possibly wanted programs or channels at the side of the low noise channel converter different user selected programs can be received simultaneously by a user. Basically the LNB now acts as a channel converter, as only the wanted channels instead of the full signal bands are RF multiplexed on the communication medium to the user units. Put otherwise, the low noise channel converter performs channel conversion in the head-end. This extends flexibility and multi-user applications, while in addition use is made of the same usually already present communication medium. So despite the extended user applications no additional communication media have to be provided between the head end and the user units or set-top boxes at the user end of the satellite receiver system.

Furthermore frequency multiplexing means are simple and easy to implement in the head end and satellite receiver system, against reduced costs.

A further advantage of the head end and satellite receiver system according to the invention is that the solution presented posses reduced linearity requirements on the receiver and communication medium to the user units, as only the actual wanted channels are put on the medium.

An embodiment of the satellite receiver system according to the invention is characterized in that the coupling between the low noise channel converter and the user units contains a single communication medium, generally a coaxial cable.

Advantageously the one coaxial cable already installed, accepted and integrated in the house environment of the user needs no troublesome and expensive adaptation or expansion.

A further embodiment of the head end and satellite receiver system respectively according to the invention is characterized in that they comprise local oscillator means coupled to the low noise channel converter.

These local oscillator means present at the low noise channel converter aid the frequency conversion and pre-selection at the upper antenna end of the communication medium.

A still further embodiment of the head end and satellite receiver system respectively according to the invention is characterized in that the local oscillator means are arranged for providing a variable local oscillator frequency.

By providing a variable local oscillator frequency the channel frequency on the communication medium or cable can be allocated freely.

Another embodiment of the head end and satellite receiver system respectively according to the invention is characterized in that the local oscillator means comprise one or more phase locked loops.

Advantageously a frequency accurate, compact and low power consuming integrated circuit implementation of such a phase locked loop is easily feasible.

Accordingly a satellite receiver system following the invention is characterized in that the head end includes a combining circuit, and that the satellite receiver system further comprises a parallel arrangement of one or more further low noise channel converters coupled to the combining circuit.

It is an advantage of the satellite receiver system according to the invention that it provides additional flexibility, as the further low noise (LN) channel converters make use of the one combining circuit present in the one master head end, while advantageously such a combining circuit is not present in relation to the further slave LN channel converters.

Alternatively it is an advantage that one may even keep all LN channel converters identical.

Another embodiment of the satellite receiver system according to the invention is characterized in that each further low noise channel converter is provided with further local oscillator means for tuning on individual user pre-selected receiving channels.

Advantageously these local oscillator means allow mingling of received channels emanating from different LN channel converters on the single communication cable.

At present the head end and satellite receiver system according to the invention will be elucidated further together with their additional advantages, while reference is being made to the appended drawings. In the drawings:

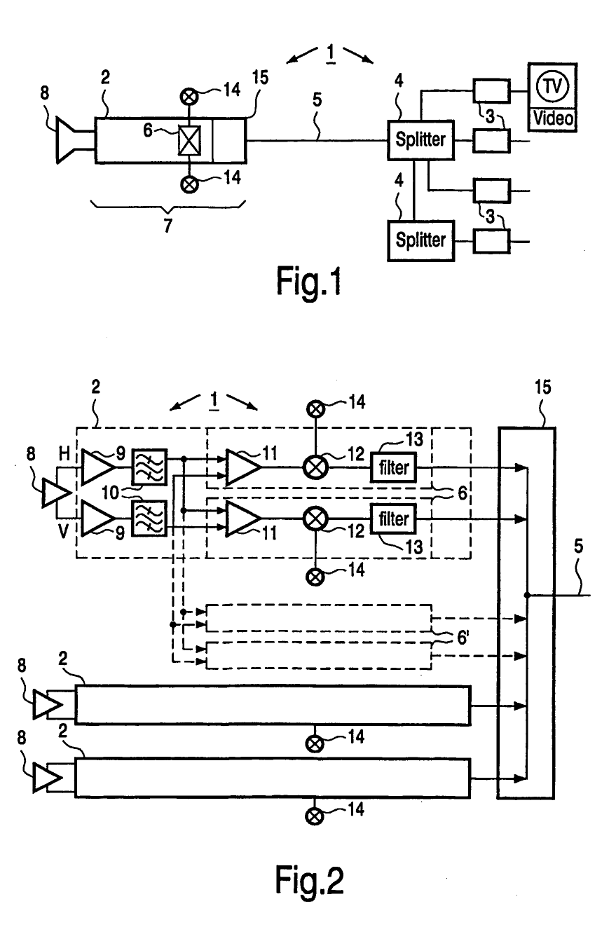

FIG. 1 shows an overall view of an embodiment of the satellite receiver system according to the invention, and

FIG. 2 shows a combination of further possible embodiments of the detailed satellite receiver system according to the present invention.

FIG. 1 shows a satellite receiver system 1 comprising a low noise converter, in the form of a low noise (LN) channel converter 2 which is coupled to an antenna 8. The satellite receiver system 1 further comprises one or more user units 3 usually coupled to the LN channel converter 2 through one or more RF power splitters 4. The user units 3 are also called set-top boxes. These units 3 are normally capable of providing a user selected input signal to a radio, television set TV, video apparatus et cetera. A user can select a channel carrying a program he or she wants to see or record on video. In the embodiment of the satellite receiver system 1 as shown in FIG. 1 the coupling between the LN channel converter 2 and the user units 3 comprises a single communication medium, here in the form of a single coaxial cable 5. The LN channel converter 2 as shown includes frequency multiplexing means 6, which are detailed in FIG. 2. The means 6 multiplex one or more channels pre-selected in the LN channel converter 2 to the user units 3. This way a single communication medium or cable 5, usually already installed between LN channel converter 2 and user units 3 can be used for receiving a great variety of programs. This way only a pre-selection of wanted channels and not the entire GHz satellite frequency band is transmitted to the user units 3. The pre-selection of programs by the multiplexing means 6 at the side of the LN channel converter 2 avoids the requirement of adding more rigid and expensive communication cables 5 between LN channel converter 2 and the user units 3. Some form of communication, either through the air, or not between the user units 3 and the LN channel converter 2 can be used to communicate the necessary data for the wanted preselection in the LN channel converter 2. A protocol suited for upward communication from the user units 3 to the LN channel converter 2 is the Digital Satellite Equipment Control (DiSEqC) protocol.

FIG. 2 schematically details the satellite receiver system 1. The system 1 as shown discloses the antenna 8, whose horizontal and vertical output signals H and V respectively are fed to respective only schematically shown low noise, for example GaAs amplifiers 9 and filters 10. After passing through isolator/switches 11 the frequency multiplexing means 6 further convert and select program frequencies to put the selected channels on the single cable 5. The frequency multiplexing means 6 comprise channel converters, usually a combination of mixers 12 and filters 13 for frequency down converting pre-selected channels to the pass-band of the communication medium 5. The system 1 comprises local oscillator means 14, which means 14 are coupled to the mixers 12 in the LN channel converter 2. The local oscillator means 14 are arranged for providing a variable local oscillator frequency, in order to allow the selected program frequency to be allocated within the cable pass-band. Of course the frequency down conversion can be effected by means of several series arranged mixer stages having appropriate local oscillator means 14. An easy to integrate and low power consuming IC implementation of the local oscillator means 14 comprises one or more phase locked loops. The satellite receiver system 1 comprises a frequency combining circuit 15 coupled to the medium 5 for putting the selected channels on the single cable medium 5. In this case output signals of two parallel connected LN channel converters 6 are combined by the combining circuit 15. In FIG. 1 the LN channel converter 2 and the combining circuit 15 coupled thereto are jointly provided with reference numeral 7, used to indicate the head end.

In a still further possible embodiment the satellite receiver system 1 comprises one master unit 2, 15 including one LN channel converter 2 and the combining circuit 15, and in addition comprises slave units in the form of further LN channel converters 2. The further LN channel converters 2 are also coupled to the now extended combining circuit 15 of the head end 7. The further parallel arrangement of LN channel converters 2 are provided with further local oscillator means 14 for tuning on other individual receiving channel frequencies.

The operation of the satellite receiver system 1 in the aforementioned system embodiments is such that instead of transmitting the full 4 GHz satellite band over the medium 5, only a pre-selection of say 4 channels is transmitted over the medium 5. This pre-selection may for example comprise the high frequency part of the vertically polarized channel received by the upper LN channel converter 2 shown in FIG. 2, the low frequency part of the horizontally polarized channel received by the middle LN channel converter 2, and the high frequency parts of the horizontally and vertically polarized channels of the lower LN channel converter 2. Advantageously the preselection can be allocated freely in the pass band of the medium 5, due to the variable though accurate PLL output frequency in the easy and compact to implement, as well as cost effective frequency multiplexing means 6. Since only the wanted channels are present on the single medium 5 between the LNB 2 and the user units 3 this poses reduced linearity requirements on the system components and medium. At wish some form of level control of the signals on the medium 5 may be integrated in the system 1.

Still another embodiment of the satellite receiver system 1 can be explained by identifying the aforementioned components 11, 12, and 13 as the channel converting means 6. The parallel arrangements of the two channel converting means 6 can now be extended by adding two further channel converting means, indicated 6′, which is indicated in FIG. 2 by dotted lines. The effect is that in that case one antenna 8 can be used for receiving different channels. For example a parallel arrangement of four channel converting means as part of the head end 7 is then capable of processing four channels simultaneously. Again dotted lines indicate the associated inputs to the combining circuit 15.

1. A head end comprising a low noise converter for providing signal bands including channels to one or more user units, characterized in that the low noise converter is arranged as a low noise channel converter, which includes frequency multiplexing means for multiplexing one or more user pre-selected channels to the user units.

2. The head end according to claim 1, characterized in that the head end comprises local oscillator means coupled to the low noise channel converter.

3. The head end according to claim 2, characterized in that the local oscillator means are arranged for providing a variable local oscillator frequency.

4. The head end according to claim 2, characterized in that the local oscillator means comprise one or more phase locked loops.

5. A satellite receiver system comprising a head end according to claim 1, characterized in that the satellite receiver system further comprises one or more user units coupled to the low noise channel converter.

6. The satellite receiver system according to claim 5, characterized in that the coupling between the low noise channel converter and the user units contains a single communication medium, generally a coaxial cable.

7. The satellite receiver system according to claim 5, characterized in that the satellite receiver system comprises local oscillator means coupled to the low noise channel converter.

8. The satellite receiver system according to claim 7, characterized in that the local oscillator means are arranged for providing a variable local oscillator frequency.

9. The satellite receiver system according to claim 8, characterized in that the local oscillator means comprise one or more phase locked loops.

10. A satellite receiver system according to claim 5, characterized in that the head end includes a combining circuit, and that the satellite receiver system further comprises a parallel arrangement of one or more further low noise channel converters coupled to the combining circuit.

11. The satellite receiver system according to claim 10, characterized in that each further low noise channel converter is provided with further local oscillator means for tuning on individual user pre-selected receiving channels.
